(19) United States
(12) Patent Application Publication
(10) Pub. No.: US 2005/0118874 A1
(43) Pub. Date: Jun. 2, 2005

(54) Filter structure and method of fabrication

(76) Inventor: Chia Ho Lin, Taipei City (TW)

Correspondence Address: Chia Ho Lin, PO Box 82-144, Taipei, TW

(21) Appl. No.: 10/735,922

(22) Filed: Dec. 16, 2003

(30) Foreign Application Priority Data
Nov. 29, 2003 (TW) 092132364

(51) Int. Cl. H01R 13/66

(52) U.S. Cl. 439/620

(57) ABSTRACT

A filter structure and the method of fabrication are disclosed. The filter comprises an insertion seat including a box body at one side thereof and a plurality of electronic modules within the box body and the external side of the box body mounted to a ground terminal, and the electronic modules and the ground terminal formed an electronic loop of the filter, and the positive and negative terminal of the electronic loop being soldered to a positive conductive wire and a negative conductive wire; and a metallic housing having an opened cavity at one side for the mounting of the insertion seat and the bottom portion of the cavity being a terminal hole and a conductive wire hole, and the conductive wire hole being extended to form an isolation mount which functions as electromagnetic wave isolation, and the external of the isolation mount being mounted with an insulated rubber mount and one end of the positive conductive wire and the negative wire from the conductive wire hole via the isolation mount to the exterior, and the ground terminal passed through the terminal hole to the exterior.

### BACKGROUND OF THE INVENTION

(a) Technical Field of the Invention The present invention relates to a filter, and in particular, to a filter structure having conductive wire, and a method of fabricating the filter.

(b) Description of the Prior Art

FIG. 6 shows a conventional filter comprising an insertion seat 4 having a box body 40 at one side thereof containing resistance 41, electric induction coil 42 and Y capacitance 43 electronic modules. A cover 400 covers the box body 40 and one side of the box body 40 is provided with a positive terminal plate 44, a negative terminal plate 45 and a ground plate 46 for connecting with the electronic modules to form into an electronic loop. One side of the insertion seat 4 and the exterior of section of the box body 40 is mounted with a metallic housing 5 such that the positive terminal plate 44, the negative terminal plate 45 and the ground plate 46 are exposed externally on the metallic housing 5.

The conventional filter employs the exposed positive terminal plate 44, the negative terminal plate 45 and the ground plate 46 soldered onto the circuit board. Therefore, more space of the circuit board is occupied, and this will affect the mounting of electronic parts. If the two terminals of the conductive wire are respectively connected to the circuit board, and the positive terminal plate 44, the negative terminal plate 45 and the ground plate 46 to improve the drawback of the occupying space, then the conductive wire will produce electromagnetic wave with the external electronic parts, which interferes with each other. In other words, the filter is not stable.

Accordingly, it is an object of the present invention to provide a filter which mitigates the above drawbacks.

### SUMMARY OF THE INVENTION

Accordingly, it is an object of the present invention to provide a filter comprising an insertion seat including a box body at one side thereof and a plurality of electronic modules within the box body and the external side of the box body mounted to a ground terminal, and the electronic modules and the ground terminal formed an electronic loop of the filter, and the positive and negative terminal of the electronic loop being soldered to a positive conductive wire and a negative conductive wire; and a metallic housing having an opened cavity at one side for the mounting of the insertion seat and the bottom portion of the cavity being a terminal hole and a conductive wire hole, and the conductive wire hole being extended to form an isolation mount which functions as electromagnetic wave isolation and the external of the isolation mount being mounted with an insulated rubber mount, and one end of the positive conductive wire and the negative wire from the conductive wire hole via the isolation mount to the exterior, and the ground terminal passed through the terminal hole to the exterior.

Another aspect of the present invention is to provide a method of fabrication of a filter comprising the steps of soldering a resistance, an electric induction coil, two Y capacitance electronic components and a ground terminal to a box body at one side of an insertion seat and soldering one end of the positive terminal of a conductive wire and the negative terminal of the conductive wire to the electronic modules to form an electronic loop of the filter; preparing a metallic housing having a terminal hole and a conductive wire hole at the bottom section thereof; mounting in sequence an isolation mount with isolating magnetic wave function and a metallic housing onto a mold by soldering at the connection thereof; passing the terminal of the positive conductive wire and the negative conductive wire into the metallic housing via the conductive wire hole, and exposing to the exterior at the other end via the isolation mount, and inserting one side of the insertion seat to the metallic housing and exposing the ground terminal via the terminal hole to the exterior, and mounting an insulation rubber mount onto the exterior of the isolation mount.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the filter structure of the present invention.

FIG. 2 is a partial sectional view of the filter structure of the present invention.

FIG. 3 is a schematic view showing the installation of the insertion seat of the filter structure of the present invention.

FIG. 4 is a schematic view showing the installation of the metallic housing of the filter structure of the present invention.

FIG. 5 is a schematic view showing the installation of the insertion seat and the metallic housing of the filter structure of the present invention.

FIG. 6 is a perspective exploded view of the filter structure of the present invention.

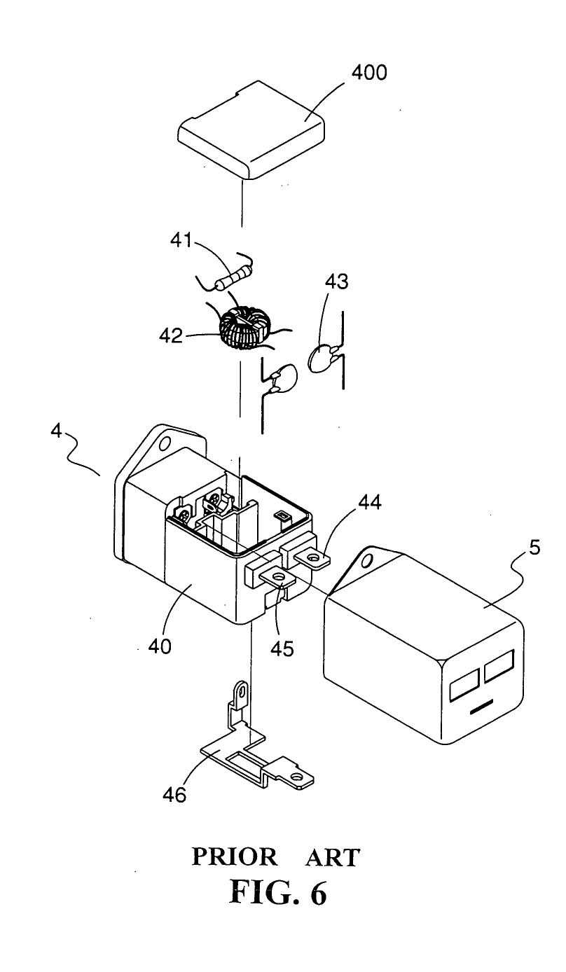

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

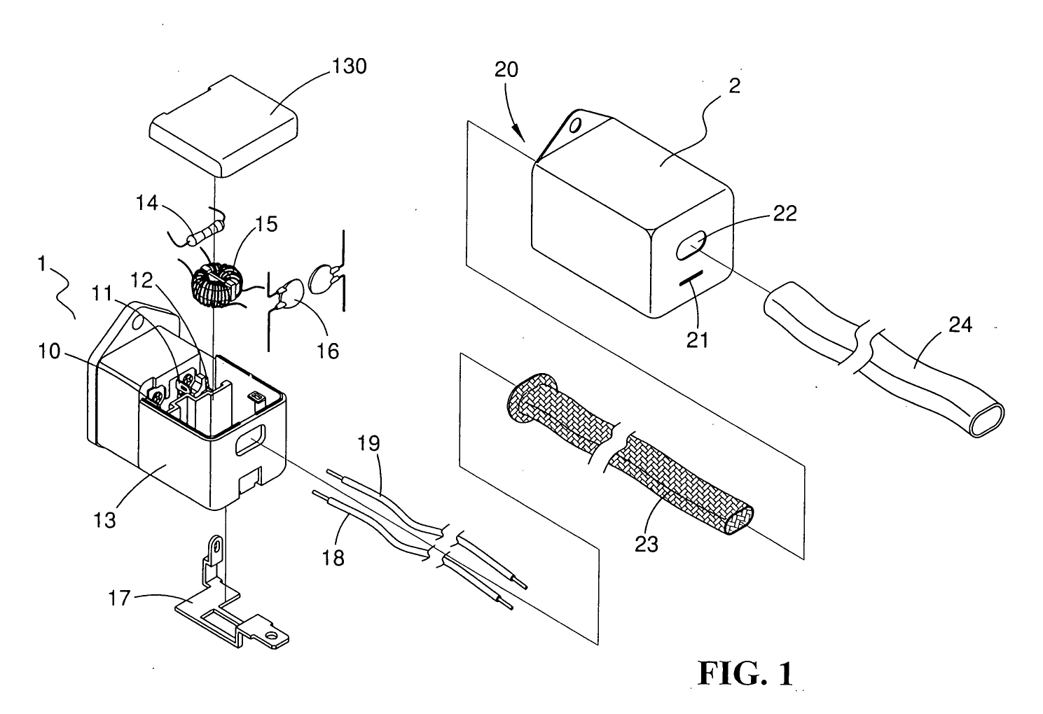

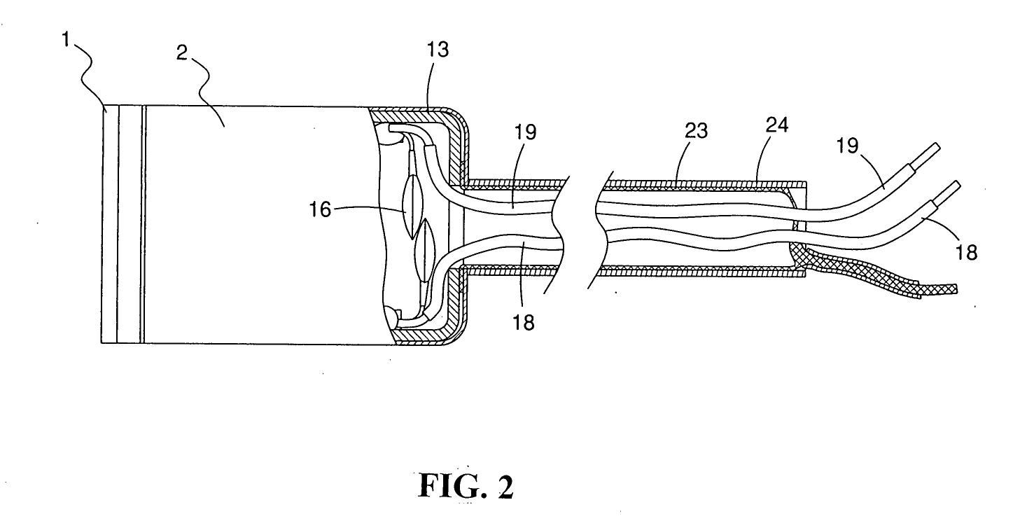

Referring to FIGS. 1 and 2, there is shown a filter structure and a method of fabrication of the filter. The filter comprises an insertion seat 1 having a positive terminal pin, a negative terminal pin and a ground terminal pin (not shown) respectively extended to another lateral side, and the lateral side being correspondingly mounted with a positive terminal pin 10, a negative terminal pin 11 and a ground terminal pin 12, and the lateral side connected to a box body 13. The box body 13 contains a resistance 14, an electric induction coil 15 and two Y capacitance electronic modules, and a cover 130 is used to cover the box body 13. The external side of the box body 13 is provided with a ground terminal 17, wherein the resistance 14, the electric induction coil 15, the Y capacitance 16 and the ground terminal 17 are respectively soldered to the positive terminal pin 10, the negative terminal pin 11 and the ground terminal pin 12 which are interconnected to form an electronic loop of the filter of the present invention. The positive terminal and the negative terminal of the electronic loop are respectively soldered to a positive conductive wire 18 and a negative conductive wire 19.

The metallic housing 2 has an opened cavity 20 at one lateral side for the mounting of the insertion seat 1 at one lateral side. The bottom end of the cavity 20 is a terminal hole 21 and a conductive wire hole 22. The conductive wire hole 22 externally extended to connect with an isolation mount 23, which is elongated and is a metallic net functioning to isolate electromagnetic wave. One end of the isolation mount 23 and the metallic housing 2 are connected by soldering, and the external of the isolation mount 23 is then mounted with an insulation rubber mount 24 so that the isolation mount 23 is covered within. One end of the positive conductive wire and the negative conductive wire are inserted from the hole 22 via the isolation mount 23 and extended to the exterior. The ground terminal 17 passes through the hole 21 to the external thereof

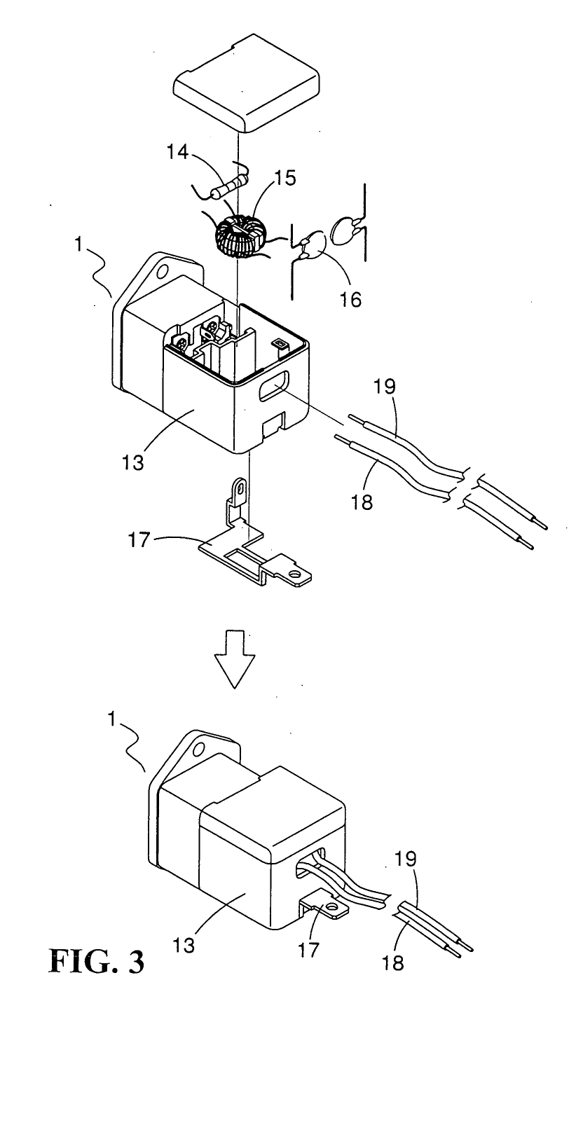

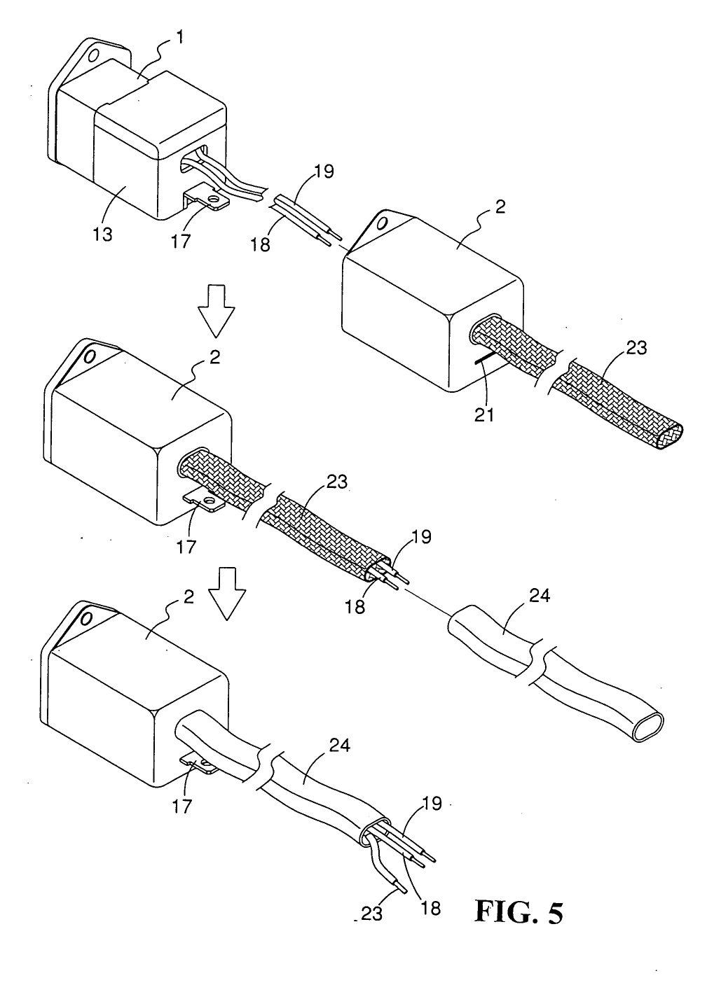

FIGS. 3 to 5 shows the method of fabrication of the filter in accordance with the present invention.

In accordance with the present invention, the method of fabrication comprises the following steps:

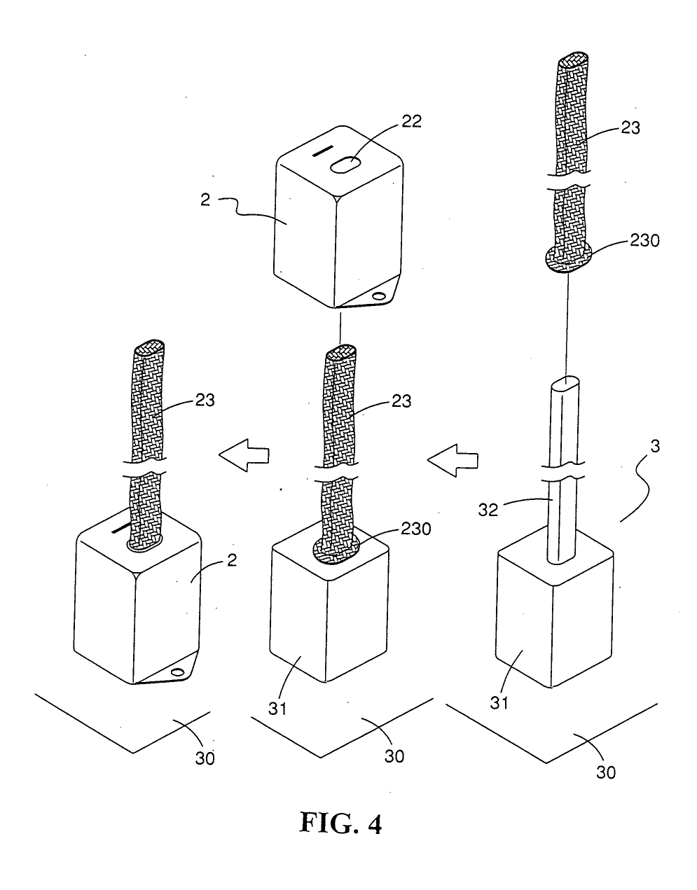

(a) soldering a resistance 14, an electric induction coil 15, two Y capacitance 16 electronic components and a ground terminal 17 to a box body 13 at one side of an insertion seat 1 and soldering one end of the positive conductive wire 18 and a negative conductive wire 19 to the electronic modules to form an electronic loop of the filter, as shown in FIG. 3;
(b) preparing a metallic housing 2 having a terminal hole 21 and a conductive wire hole 22 at the bottom section thereof;
(c) mounting in sequence an isolation mount 23 with isolating magnetic wave function and the metallic housing 2 onto a mold 3 by soldering at the connection thereof, as shown in FIG. 4, wherein the mold 3 has a molding block 31 and the molding block 31 is provided with a mold pillar 32, and the isolation mold 23 and the metallic housing 2 are combined by extending one end of the isolation mount 23 to form a flat portion as a soldering section 230 and then one end of the soldering section 230 is mounted to the molding pillar 31, and the soldering connection section 230 is flatly mounted to the top section of the molding block 31 and after that the conductive wire hole 22 passes through the other end of the isolation mount 23 and the metallic housing 2 is inserted to the molding block 31 and the connection region is then soldered;
(d) passing the terminal of the positive conductive wire 18 and the negative conductive wire 19 into the metallic housing 2 via the conductive wire hole 22, and exposing to the exterior at the other end via the isolation mount 23, and inserting one side of the insertion seat 1 to the metallic housing 2 and exposing the ground terminal 17 via the terminal hole 21 to the exterior; and
(e) mounting an insulation rubber mount 24 onto the exterior of the isolation mount 23; and
(f) rolling the end portion of the isolation mount 23 into thread and protrudedly exposed at the external of the insulation rubber mount 24.

Accordingly, a filter with conductive wire is formed in accordance with the present invention.

In accordance with the present invention, the positive conductive wire 18 and the negative conductive wire 19 are fully covered by the isolation mount 23, and the isolation mount 23 has the effect of isolating electric magnetic wave. Thus, the filter, by means of the extension of the appropriate length of the positive conductive wire 18 and the negative conductive wire 19, provides a convenient effect without occupying space. Besides, the electronic magnetic wave is eliminated.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A filter comprising:
an insertion seat including a box body at one side thereof and a plurality of electronic modules within the box body and the external side of the box body mounted to a ground terminal, and the electronic modules and the ground terminal formed an electronic loop of the filter, and the positive and negative terminal of the electronic loop being soldered to a positive conductive wire and a negative conductive wire; and
a metallic housing having an opened cavity at one side for the mounting of the insertion seat and the bottom portion of the cavity being a terminal hole and a conductive wire hole, and the conductive wire hole being extended to form an isolation mount which functions as electromagnetic wave isolation, and the external of the isolation mount being mounted with an insulated rubber mount, and one end of the positive conductive wire and the negative wire from the conductive wire hole via the isolation mount to the exterior, and the ground terminal passed through the terminal hole to the exterior.

2. The filter of claim 1, wherein the electronic modules includes a resistance, an electric induction coil and two Y capacitance.

3. The filter of claim 1, wherein the isolation mount is soldered to the metallic housing.

4. A method of fabrication of a filter comprising the steps of:
(a) soldering a resistance, an electric induction coil, two Y capacitance electronic components and a ground terminal to a box body at one side of an insertion seat and soldering one end of the positive terminal of a conductive wire and the negative terminal of the conductive wire to the electronic modules to form an electronic loop of the filter,
(b) preparing a metallic housing having a terminal hole and a conductive wire hole at the bottom section thereof,
(c) mounting in sequence an isolation mount with isolating magnetic wave function and a metallic housing onto a mold by soldering at the connection thereof;
(d) passing the terminal of the positive conductive wire and the negative conductive wire into the metallic housing via the conductive wire hole, and exposing to the exterior at the other end via the isolation mount, and inserting one side of the insertion seat to the metallic housing and exposing the ground terminal via the terminal hole to the exterior, and
(e) mounting an insulation rubber mount onto the exterior of the isolation mount.

5. The method of claim 4, wherein in step (c), the mold includes a mold seat having a molding block and the molding block includes a molding pillar.

6. The method of claim 5, wherein in step (c), the connection between the isolation mount and the metallic housing including the steps of:
(c1) extending one end of the isolation mount to form a flat soldering section;
(c2) mounting one end of the soldering section onto the molding pillar and the soldering section being soldered flat at the top section of the mold block;
(c3) inserting the other end of the isolating mount via the conductive wire hole so that the metallic housing is installed on the mold block; and
(c4) soldering the isolating mount and the metallic housing at the connection thereof.

7. The method of claim 4, wherein in step (e), the terminal section of the isolation mount is rolled into thread like and exposed at the exterior of the insulated rubber mount.
